(19) United States
(12) Patent Application Publication
(10) Pub. No.: US 2010/0026195 A1
(43) Pub. Date: Feb. 4, 2010

(54) Multi-Modal Light

(76) Inventor: Noel R. Potter, Woods Cross, UT (US)

Correspondence Address: Noel R. Potter, 874 W 2150 S, Woods Cross, UT, 84087, US

(21) Appl. No.: 12/181,818

(22) Filed: Jul. 29, 2008

(51) Int. Cl. H05B 37/02

(52) U.S. Cl. 315/158

(57) ABSTRACT

The invention is a light that operates in many different modes based on a settings switch and environmental conditions such as ambient light levels and the detection of movement near the light. In one of the modes, the light will only come on after a darkness threshold has been reached and movement is detected near the light. By limiting when the light is on maximizes the amount of time the light can operate without recharging the energy storage unit. In another mode, the light comes on when there is movement detected near the light regardless of the darkness threshold conditions. A walk-in closet light is an example of this type of light use. In all modes the light will operate for multiple days without power being available to recharge the energy storage unit. In each mode, the light brightness is determined by the brightness control. Lowering the brightness will increase the time the light will operate without an external power source to recharge the energy storage unit.

### CROSS-REFERENCE TO RELATED APPLICATIONS

None

### FEDERALLY SPONSORED RESEARCH

None

### SEQUENCE LISTING

None

### BACKGROUND

Most light bulbs used in homes are conventional incandescent light bulbs that range from 40 watts to 100 watts per light bulb. It is estimated that almost one-fourth of the energy used in homes is used for lighting. Unfortunately, most homes still use the traditional incandescent light bulbs invented by Thomas Edison over 100 years ago. These bulbs convert only about 10 percent of the electricity they use to produce light; the other 90 percent is converted into heat. Many homeowners are changing out their inefficient incandescent light bulbs and are using the newer florescent light bulbs that use less power for the light they emit. While this is an improvement, there is still a lot of room to improve the efficiency of lighting.

Because lighting represents one fourth of the energy used in a home, the amount of power required to power lighting in a home is a very large number. When you consider there are over 111 million households in the United States, with the average electric bill at around $90 per month, the amount of money going to pay for household lighting across the United States is around $2.4 Billion dollars each year. The area of lighting efficiency is an area that provides a huge opportunity to reduce energy costs in a home if a device can be developed that will further reduce the amount of energy wasted in unneeded lighting cost. Almost without exception, every night in every home, one or more lights are left on in rooms without anyone there to need the lighting. Many millions of dollars of electricity are wasted every year because lights are left on when they are not needed because no one is in the room to need the light. This represents another area where lighting costs can be reduced.

There are more and more family households that are seeking ways to reduce the cost of energy. Some households are turning to alternate energy sources such as solar or wind generation either to reduce energy costs or in some cases to provide the only source of energy for a home. Many of the households in the United States are off the national power grids and use wind or solar energy as their only source of energy. Because of the limited amount of electrical energy that is stored from alternate forms of power generation, those who use solar or wind energy are very concerned with how the energy that is generated is used, they are constantly looking for ways to cut electrical usage and lighting represents an area where energy usage can be reduced if an improvement in lighting technology could be found. Many times the alternate electrical generation source will produce a marginal amount of power because of a lack of wind in the case of wind energy or lack of sun for solar energy due to clouds covering the sun making energy conservation a must.

Sometimes even the most simple and mundane things become extravagant when energy is at a premium or even not available certain times of the day. Having enough light for a student to study by at night or even a night light can be a real luxury if the household is run off of a battery system that is charged during the day by wind or solar sources. Most of the alternate energy homes use inverters to change the 12 or 24 volt battery voltage into 120 VAC, because of the lack of a low voltage lighting system. Much of the energy is wasted during the conversion to 120 VAC in order to use lighting systems that use 120 VAC.

### SUMMARY

The invention is a light that monitors the environment and changes its operating characteristics based on switch settings and the information gathered. The light source is coupled to an energy storage unit that can power the light source in response to a need for lighting whether or not there is external power available. The light is also connected to a proximity sensor to detect movement. The proximity sensor is configured to activate the light if movement is detected. The ambient light is monitored to determine if the ambient light level is below a darkness threshold value. The light also has a brightness control to be able to lower the brightness of the light to conserve energy supplied by the energy storage unit. The light can be configured to operate in different modes based on a switch setting. The light can be powered directly off of a low voltage alternative energy storage system without the need for an energy consuming voltage inversion.

### SUMMARY OF DRAWINGS

FIG. 1 is a block diagram showing the various components of the light system.

FIG. 2 is a flow diagram showing the processor program during start-up and the charging sequence of the onboard energy unit.

FIG. 3 is a flow diagram showing how the processor reads the various detectors, sensors, and user interface and then determines the brightness level of the light.

### DETAILED DESCRIPTION OF DRAWINGS

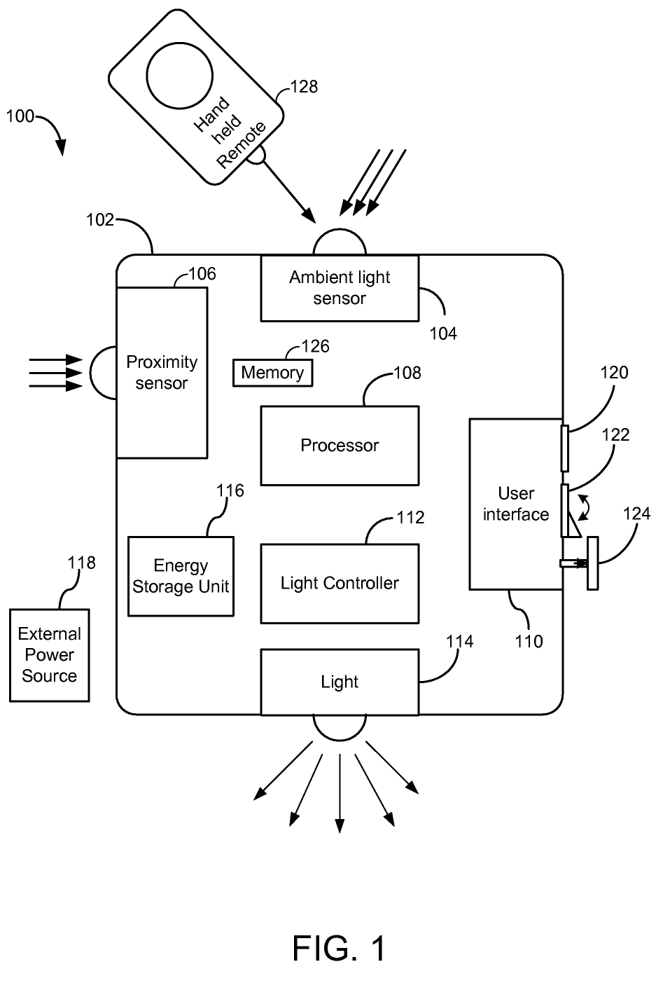

FIG. 1 is a block diagram of the various components of the light system. The energy to run the Processor 108 and all the components is supplied by the energy storage unit 116. The processor 108 controls the operation of the system and reads the proximity sensor 106, the Ambient Light Detector 104 and the User Interface 110 to determine the level of brightness of the Light 114. The brightness input is adjusted by the user to set the average brightness level of the light 114 through the processor 108. If it is dark enough but the Proximity Sensor 106 does not sense anyone nearby, the light remains off. When the proximity sensor 106 detects movment and the ambient light detector 104 reaches a darkness threshold to indicate a need for the light 114, the processor sets the light brightness determined by the user controlled brightness Input 124. The energy storage unit 116 is a rechargeable storage unit and is recharged by an external power source 118. The user Interface also has two switches, the settings switch 120 is used to determine the light system operating mode. Toggle Switch 122 is a system on-off switch.

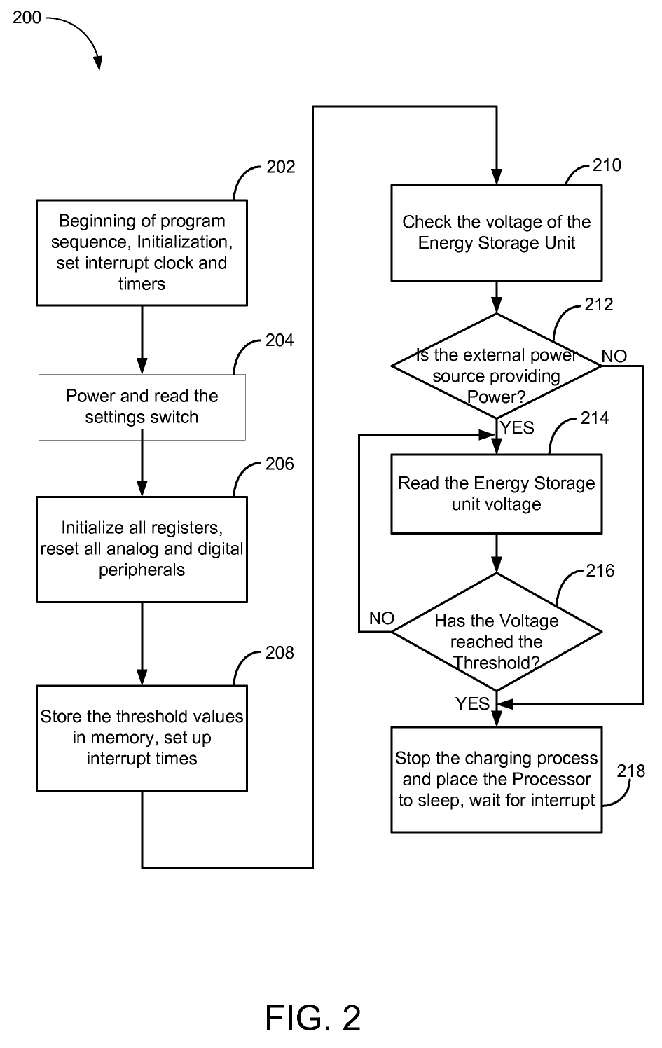

FIG. 2 is a flow chart 200 of the start-up routine for the processor for one embodiment of the light. The processor sets up the interrupt clocks and timers 202, then reads the settings switch 204. The processor then initializes all the sensors and then stores the threshold values in memory 208. The processor then checks to see if outside charging power is available 212 and then recharges the energy storage unit if it is, if necessary, and then waits for an interrupt 218.

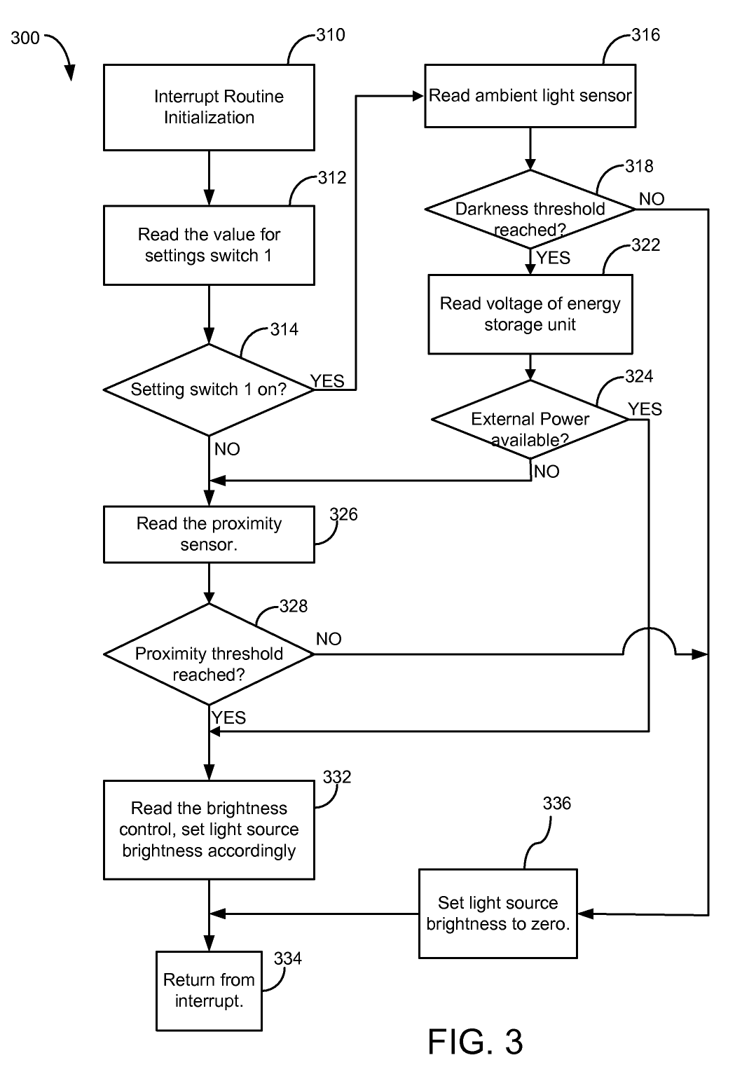

FIG. 3 is a flow chart 300 of one of the modes of operation of the light. When the interrupt routine 300 starts, the processor 108 goes through interrupt initialization 310 and then retrieves the value read from the settings switch. The first bit of the settings switch value is then tested to evaluate the position of the switch 312. If the first bit indicates that switch 1 of the settings switch 120 is off, the program directs the processor 108 to read the proximity sensor 106 value 326 to see if movement has been detected 314. If not, it sets the brightness level of the light to zero 336 and returns from interrupt 334. If the first bit of the settings switch 120 has been set 314, the processor is directed to read the ambient light sensor 316. If the ambient light darkness threshold 318 has been reached, the processor checks to see if the outside charging power is available 322 and if it is, the processor reads the brightness control and then sets the brightness level 332 for the light and then returns from interrupt 334. If the outside charging power is not available, the processor reads the proximity sensor 326 and checks to see if the proximity threshold has been reached 318. If the proximity threshold has not been reached, the processor sets the light brightness to zero 336 and then returns from interrupt 334. If proximity threshold has been reached the processor reads the brightness control and the brightness of the light is set accordingly 332. Then the program instructs the processor to return from interrupt 334.

### REFERENCE NUMERALS FOR FIG. 1

100. Light system
102. Light Housing
104. Ambient Light Sensor
106. Proximity Sensor
108. Processor
110. User Interface
112. Light Controller
114. Light
116 Energy Storage Unit
118. External Power Source
120. Settings Switch
122. Toggle Switch
124. Brightness Control Input
126. Memory
128. Hand Held Remote

### Operation

The light is designed to replace one or more conventional lights in a house with a relatively low power and substantially more efficient lighting source. The light system has an 8 position settings switch, and each combination of switch settings provides a possible mode of operation. An 8 position settings switch provides enough combinations for 256 different operating modes for programming the light.

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

The light system has a proximity sensor that detects whether anyone is near the light. The proximity sensor could be a infra-red sensor that detects infra-red radiation from human beings using a passive infra-red detection device. The proximity sensor could also be a Doppler radar detection system that detects movement. Infra-red sensing optical diodes could also be used to detect human infra-red radiation. The proximity detection system is not limited to the sensors mentioned herein and could use any device or system that can detect movement.

The light system has an ambient light sensor that utilizes a device that can measure the level of ambient light near the light system. This device could be a cadmium sulfide cell that changes resistance based on light impinging on the cell. Optical diodes could also be used to detect ambient light as well as any other device that can create a signal based on the level of ambient light near the light source.

Some of the embodiments of the light system have a user adjustable brightness control that changes the maximum level of light emitted by the light source. A simple potentiometer coupled to a dial could provide the user control of the brightness. Also, a remote device could be used to adjust the brightness utilizing a infra-red detector to receive the remote brightness control signal, or it could utilize an ambient light sensor to detect a remote brightness control signal. The brightness is controlled is through Pulse Width Modulation (PWM) that is generated by the processor and is coupled with the Light Controller to vary the on and off periods of the light thousands of times per second to adjust the brightness. The on-off ratio determines the brightness. With this type of brightness control it is possible to go from totally off to totally on in small increments.

The light system utilizes an energy storage unit that powers the light system. The energy storage unit can be recharged from the Alternating Current (AC) power grid through a battery charger. It can also be recharged by an alternate energy generation system such as power generated by solar panels or power generated by a wind turbine. It can be recharged by any other power generation system including a generator. The energy storage unit could be a rechargeable lead acid battery system, or it could be a battery system made up of a plurality of nickel metal hydride battery cells, or it could be made up of a plurality of Lithium-ion battery cells. The energy storage unit can be made from any rechargeable energy storage components.

In one embodiment, the light system is used in a hallway to provide a light at night when movement is detected in the hallway. The light will only come on when a darkness threshold is reached as detected by the ambient light sensor and the proximity sensor detects movement in the hallway. The light source will contain 1 or more LEDs or any other light source that has comparable or better efficiency than an LED. For example, one embodiment of the light system includes four 1 watt LED light sources that provide as much or more light than a medium wattage (40-60 watts) incandescent light bulb with approximately 4 watts of total power consumption. Some embodiments of the light system include a brightness control. The brightness control includes a lower limit of zero current and an upper limit of a maximum current. For example, one embodiment of the light system includes a maximum current of 300 milliamps. With the four 1 watt LED light sources, the total power consumption is approximately 4 watts at 300 milliamps. The brightness control allows a user to adjust the brightness of the light system. The power consumption may be substantially less than 4 watts if the brightness is reduced to a minimum operating current level. For example, in one embodiment, the minimum average operating current level is 10 milliamps and the power consumption is 0.13 watts. By lowering the brightness level of the light it is possible for the light to provide multiple nights of use without the availability of external power to recharge the energy storage unit. Since the light turns off when movement is not detected, energy is conserved by not leaving the light on at all times after a darkness threshold has been reached. Since the light only comes on after the darkness threshold has been reached, except for recharging the energy storage unit, there is little or no power consumed by the light system from external power sources during the day.

In another embodiment, the light is placed in a walk-in closet to provide light whenever someone walks into the closet. In this embodiment, the light comes on when movement is detected without taking the ambient light level into consideration. The light's brightness level can be set by changing the brightness control. Since the light has an energy storage unit, the light will operate even when no outside power is available to power the device. Since it is used only short periods of time each day, the light is able to operate for multiple nights without the availability of external power.

In another embodiment, the apparatus is configured with multiple lights spaced below a cupboard with the lights pointing down to provide countertop lighting. In this configuration, the ambient light sensor measures the amount of light available on the countertops and the brightness control of the light system works in conjunction with the ambient light sensor to provide a desired level of light to the countertops. The lights are activated when movement is detected and remain on for a period of time determined by the settings switch. Each detection of movement would extend the period of time that the lights would remain on.

In yet another embodiment, the light system is configured as track lighting installed above an area such as an eating area. The light system is activated by movement detection. The lights stay on for a period of time after the movement is detected based on switch settings. The settings switch could be set to allow the light to remain on after movement detection for multiple periods of time. In this embodiment the ambient light system is configured, in addition to detecting a darkness threshold, to detect the light from a hand held brightness control. Because the light system would be mounted at the ceiling near the track lighting, a hand held remote brightness control would enable the brightness to be changed remotely by utilizing the light system's ambient light sensor.

What is claimed is:

1. A system comprising:
an energy storage unit to provide power to the system;
a light source coupled to the energy storage unit, the light source to emit light; and,
a proximity sensor coupled to the light source to detect movement, wherein the proximity sensor is configured to activate the light source in response to a detection of movement.

2. The system of claim 1, further comprising a brightness control coupled to the light source, the brightness control to adjust the brightness of the light source.

3. The system of claim 2, further comprising an ambient light sensor coupled to the light source, the ambient light sensor to detect the level of light near the light source.

4. The system of claim 3, further comprising a settings switch coupled to the light system, the settings switch to change the operating mode of the light system.

5. The system of claim 4, further comprising a processor coupled with the light source, the brightness control, the proximity sensor, the ambient light sensor, and the settings switch, wherein the processor is configured to execute a command associated with a function of the light source.

6. The system of claim 5, wherein the processor further comprises:
a multiple input analog to digital converter to read the various sensors, and the brightness control; and,
a memory to store the processor commands and the threshold values for the light system.

7. The system of claim 6, further comprising a hand-held remote brightness control to adjust the brightness of the light system when the light source is mounted in a difficult to reach location.

8. The system of claim 1, wherein the light source comprises at least one LED.

9. An apparatus comprising:
a energy storage means to power the light source, the processor, and the other circuits associated with the light source;
a light emitting means to provide emitted light; and,
a proximity sensor means to detect movement.

10. The apparatus of claim 9 further comprising a brightness control means to allow the user to control the brightness of the light emitting means.

11. The apparatus of claim 10, further comprising an ambient light sensor means to detect light near the apparatus.

12. The apparatus of claim 11, further comprising a settings switch means to change the operating mode of the light source.

13. The apparatus of claim 12, further comprising a processor means wherein the processor means is configured to execute a command associated with a function of the apparatus.

14. The apparatus of claim 13, wherein the processor further comprises:
a multiple input analog to digital converter means to read the various sensors, and the brightness control; and,
a memory means to store the processor commands and the threshold values for the apparatus.

15. A method comprising:
providing power to the light source using an energy storage unit;
emitting light from a light source coupled to the energy storage unit; and,
detecting movement with a proximity sensor configured to activate the light source in response to a detection of movement.

16. The method of claim 15, further comprising:
changing the brightness of the light source by adjusting a brightness control.

17. The method of claim 15, further comprising:
detecting the ambient light near the light source using an ambient light sensor coupled to the light source.

18. The method of claim 17, further comprising:
reading a settings switch to determine the operating characteristics of the light source.

19. The method of claim 18, further comprising:
reading the brightness control, the proximity sensor, the ambient light sensor, and the settings switch, utilizing a processor that is configured to execute commands associated with a mode of the light source.

20. The method of claim 19, further comprising:
adjusting the brightness of the light system utilizing a hand held remote when the light source is mounted in a difficult to reach location.
